(19) United States
(12) Patent Application Publication
(10) Pub. No.: US 2018/0292685 A1
(43) Pub. Date: Oct. 11, 2018

(54) Repair Circuit and Repair Method for a Display Substrate, as well as Display Substrate and Display Device

(71) Applicants: BOE TECHNOLOGY GROUP CO., LTD., Beijing (CN); BEIJING BOE DISPLAY TECHNOLOGY CO., LTD., Beijing (CN)

(72) Inventors: Jinglong YANG, Beijing (CN); Wei ZHANG, Beijing (CN); Yanqi LI, Beijing (CN); Yanfei WANG, Beijing (CN); Zhanxing LIU, Beijing (CN)

(21) Appl. No.: 15/567,877

(22) PCT Filed: May 19, 2017
(86) PCT No.: PCT/CN2017/084989

§ 371 Date: Oct. 19, 2017

(30) Foreign Application Priority Data
Oct. 20, 2016 (CN) 201610913673.5

(51) Int. Cl. G02F 1/13; G02F 1/1345

(52) U.S. Cl. CPC G02F 1/1309; G02F 1/13452

(57) ABSTRACT

The present application discloses a repair circuit for a display substrate. The display substrate comprises a display region and a lead region arranged outside the display region. The repair circuit comprises: a first repair line, arranged at a side of the lead region away from the display region and intersecting with a lead wire in the lead region; a second repair line, arranged at a side of the lead region close to the display region and intersecting with a lead wire in the lead region; and a third repair line that connects the first repair line to the second repair line, wherein the lead wire in the lead region is electrically insulated from the first repair line and the second repair line. The present application further discloses a display substrate, a display device and a repair method for a display substrate.

### RELATED APPLICATION

The present application claims priority of the Chinese patent application No. 201610913673.5 filed on Oct. 20, 2016, all contents of which are incorporated herein by reference.

### TECHNICAL FIELD

The present application relates to the field of display technology. Particularly, the present application relates to a repair circuit and a repair method for a display substrate, as well as a display substrate comprising the repair circuit and a display device comprising the display substrate.

### BACKGROUND

Display substrates have been widely applied in various display devices. In order to meet requirements such as high resolution and/or miniaturization of various display devices, widths of electrodes in the internal circuit of the display substrate becomes smaller and smaller, and the possibility that electrode disconnections occur in the internal circuit of the display substrate becomes greater and greater.

For a thin film transistor liquid crystal display (TFT-LCD), the internal circuit of the display device mainly comprises a gate circuit, a source electrode and a common electrode. When the source circuit is disconnected in a display region of the display substrate, it can be generally repaired by a laser device using a reserved data open (DO) repair circuit within the display substrate. However, when a lead portion of the source circuit is disconnected in a fan-out region, i.e., when lead open (LO) occurs, it cannot be repaired using any repair circuits within the display substrate.

In related arts, when the open position of the lead circuit is located outside the liquid crystal cell, it can be repaired using a panel pad repair (PPR) device. However, when the open position of the lead circuit is located within the liquid crystal cell, it cannot be repaired.

As for a disconnection of the lead circuit that occurs inside the liquid crystal cell, poor products can be only discarded as useless, since they cannot be repaired using the PPR device. Thus, the maintenance ratio of the display substrate where a lead circuit disconnection occurs is reduced. In addition, because the PPR device has to deposit tungsten powder on the electrode surface, it may be easily affected by the cleanliness of the electrode region. Thereby, the maintenance time is caused to be longer, and the maintenance success ratio is caused to be lower.

### SUMMARY

The present application aims to propose a repair circuit and a repair method for a display substrate, so that a lead circuit disconnection that occurs inside and outside the liquid crystal cell can be both repaired. In addition, the present application further provides a display substrate comprising the repair circuit and a display device comprising the display substrate.

According to an aspect of the present application, a repair circuit for a display substrate is provided. The display substrate comprises a display region and a lead region arranged outside the display region. The repair circuit comprises: a first repair line, arranged at a side of the lead region away from the display region and intersecting with a lead wire in the lead region; a second repair line, arranged at a side of the lead region close to the display region and intersecting with a lead wire in the lead region; and a third repair line that connects the first repair line to the second repair line, wherein the lead wire in the lead region is electrically insulated from the first repair line and the second repair line.

According to an embodiment of the present application, a data signal can be provided to a data line arranged in the display region through a lead wire arranged in the lead region.

According to an embodiment of the present application, the lead region can comprise an integrated circuit bonding region and a fan-out region adjacent to the integrated circuit bonding region, wherein the fan-out region can be arranged between the integrated circuit bonding region and the display region. The first repair line can be arranged at a side of the integrated circuit bonding region away from the display region, and the second repair line can be arranged between the fan-out region and the display region.

According to an embodiment of the present application, a lead wire arranged in the fan-out region can comprise a snakelike lead wire and a fan-out line that connects the snakelike lead wire to a data line arranged in the display region.

According to an embodiment of the present application, the first repair line and the second repair line are configured, when the lead wire arranged in the lead area is disconnected, to be electrically connected with the disconnected lead wire respectively, so as to repair the disconnected lead wire through a conductive path formed by the first repair line, the second repair line as well as the third repair line connected to the first repair line and the second repair line.

According to an embodiment of the present application, the first repair line and the second repair line can be electrically connected with the disconnected lead wire respectively through a laser welding method.

According to an embodiment of the present application, the repair circuit can further comprise: a fourth repair line, arranged at a side of the display region away from the lead region, and intersecting with but insulated from a data line arranged in the display region, wherein the third repair line connects the first repair line and the second repair line to the fourth repair line.

According to an embodiment of the present application, the fourth repair line and the second repair line are configured, when a data line arranged in the display region is disconnected, to enable the fourth repair line to be electrically connected with the disconnected data line, and enable the second repair line to be electrically connected with a lead wire that is connected to the disconnected data line, so as to repair the disconnected data line through a conductive path formed by the second repair line, the fourth repair line as well as the third repair line connected to the second repair line and the fourth repair line.

According to an embodiment of the present application, the fourth repair line can be electrically connected with the disconnected data line and the second repair line can be electrically connected with a lead wire connected to the disconnected data line through a laser welding method.

According to another aspect of the present application, a display substrate is provided, comprising a display region, a lead region arranged outside the display region, and the repair circuit according to the present application.

According to another aspect of the present application, a display device is provided, comprising the display substrate according to the present application.

According to another aspect of the present application, a repair method for a display substrate is provided. The display substrate comprises a display region and a lead region arranged outside the display region. The repair circuit comprises: a first repair line, arranged at a side of the lead region away from the display region, and intersecting with a lead wire in the lead region; a second repair line, arranged at a side of the lead region close to the display region, and intersecting with a lead wire in the lead region; and a third repair line that connects the first repair line to the second repair line, wherein the lead wire in the lead region is electrically insulated from the first repair line and the second repair line. The repair method comprises: when the lead wire arranged in the lead region is disconnected, enabling the first repair line and the second repair line to be electrically connected with the disconnected lead wire respectively, so as to repair the disconnected lead wire through a conductive path formed by the first repair line, the second repair line as well as the third repair line connected to the first repair line and the second repair line.

According to an embodiment of the present application, the first repair line and the second repair line can be electrically connected with the disconnected lead wire respectively through a laser welding method.

According to an embodiment of the present application, the repair circuit can further comprise: a fourth repair line, arranged at a side of the display region away from the lead region, and intersecting with but insulated from a data line arranged in the display region, wherein the third repair line connects the first repair line and the second repair line to the fourth repair line. The repair method can further comprise: when the data line arranged in the display region is disconnected, enabling the fourth repair line to be electrically connected with the disconnected data line, and enabling the second repair line to be electrically connected with a lead wire that is connected to the disconnected data line, so as to repair the disconnected data line through a conductive path formed by the second repair line, the fourth repair line as well as the third repair line connected to the second repair line and the fourth repair line.

According to an embodiment of the present application, the fourth repair line can be electrically connected with the disconnected data line and the second repair line can be electrically connected with a lead wire connected to the disconnected data line through a laser welding method.

In the repair circuit and repair method for a display substrate according to the present application, when the lead wire arranged in the lead region of the display substrate is disconnected, the disconnected lead wire can be repaired through a lead open (LO) repair circuit reserved in the display substrate, without having to consider whether the lead open occurs inside or outside the liquid crystal cell. The LO repair circuit can comprise the above described first to third repair lines. Hence, the repair circuit and repair method for a display substrate according to the present application can repair the lead open that occurs both inside and outside the liquid crystal cell.

### BRIEF DESCRIPTION OF THE DRAWINGS

The concept of the present application can be understood more clearly through the following detailed description in conjunction with the drawings, wherein:

FIG. 1 is a schematic view that shows a repair circuit for a display substrate according to an embodiment of the present application;

FIG. 2 is a schematic view that shows a repair circuit for a display substrate according to another embodiment of the present application; and

FIG. 3 is a schematic view for explaining how a display substrate is repaired using the repair circuit according to an embodiment of the present application.

### DETAILED DESCRIPTION OF THE EMBODIMENTS

In the following, exemplary embodiments that reflect the concept of the present application will be described with reference to the drawings. However, the concept of the present application can be carried out in various forms and should not be understood as being limited to the exemplary embodiments expounded in this text. On the contrary, these exemplary embodiments are provided so as to enable this disclosure to be thorough and complete, and convey the concept of the present application to the ordinary skilled person in the art completely. However, it should be understood that it is not intended to limit the concept of the present application to the particular forms as disclosed. But on the contrary, the concept of the present application intends to cover all amendment forms, equivalent forms and replacement forms that fall within the spirit and scope of the concept of the present application. In the drawings, the size of different structures is exaggerated in order to make the concept of the present application to be clear.

It should be understood that the term “and/or” as used in the present application includes any and all combinations of one or more of the related listed items. When expressions such as “at least one of . . . ” come up before a list of elements, it modifies the entire list rather than modifying a single element in the list.

In addition, although terms such as “first” and “second” are used in embodiments according to the concept of the present application to describe multiple members, components, regions, layers and/or portions, these members, components, regions, layers and/or portions should not be limited by these terms. These terms are only used for distinguishing one member, component, region, layer or portion from another member, component, region, layer or portion. Hence, the member, component, region, layer or portion that is called a first member, a first component, a first region, a first layer or a first portion in any embodiments can also be called a second member, a second component, a second region, a second layer or a second portion, without departing from the teaching of the present application.

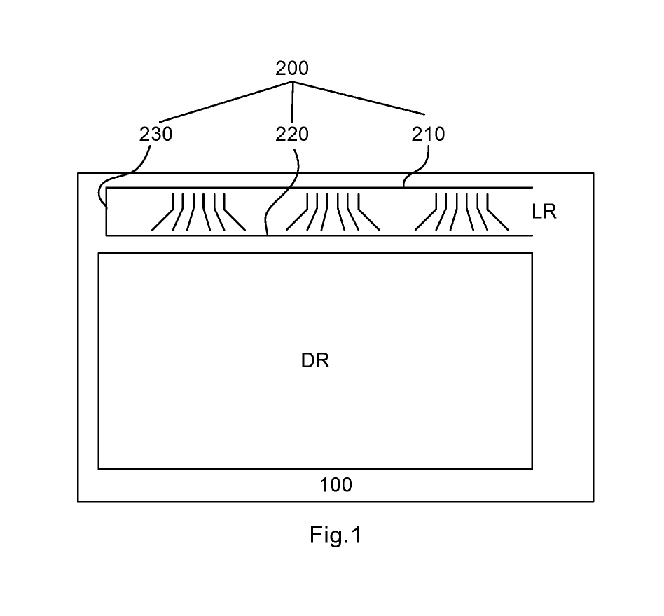

FIG. 1 is a schematic view that shows a repair circuit for a display substrate according to an embodiment of the present application.

As shown in FIG. 1, a display substrate 100 can comprise a display region DR and a lead region LR arranged outside the display region DR. A repair circuit 200 for the display substrate 100 can comprise: a first repair line 210, arranged at a side of the lead region LR away from the display region DR, and intersecting with a lead wire in the lead region LR; a second repair line 220, arranged at a side of the lead region LR close to the display region DR, and intersecting with the lead wire in the lead region LR; and a third repair line 230 that connects the first repair line 210 to the second repair line 220, wherein the lead wire in the lead region LR is electrically insulated from the first repair line 210 and the second repair line 220.

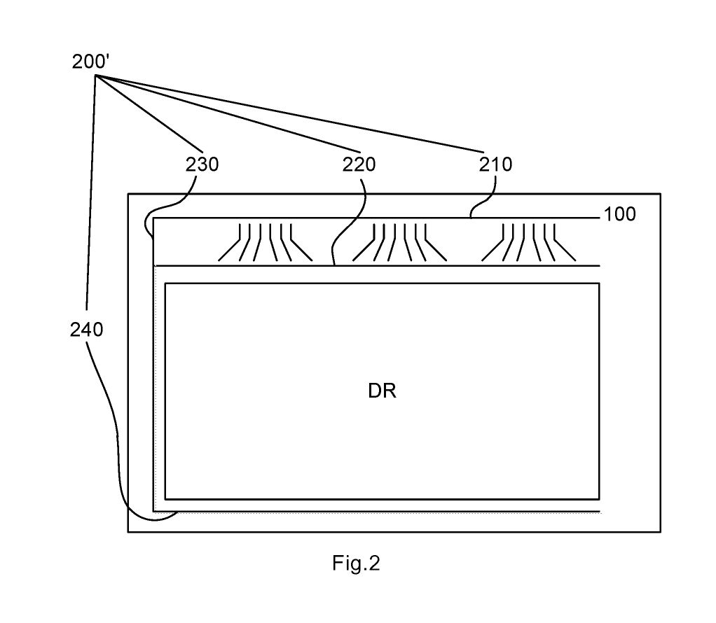

FIG. 2 is a schematic view that shows a repair circuit for a display substrate according to another embodiment of the present application.

As shown in FIG. 2, a repair circuit 200′ for the display substrate 100 according to another embodiment of the present application can also comprise: a fourth repair line 240, arranged at a side of the display region DR away from the lead region LR, and intersecting with but insulated from a data line arranged in the display region DR. The third repair line 230 connects the first repair line 210 and the second repair line 220 to the fourth repair line 240.

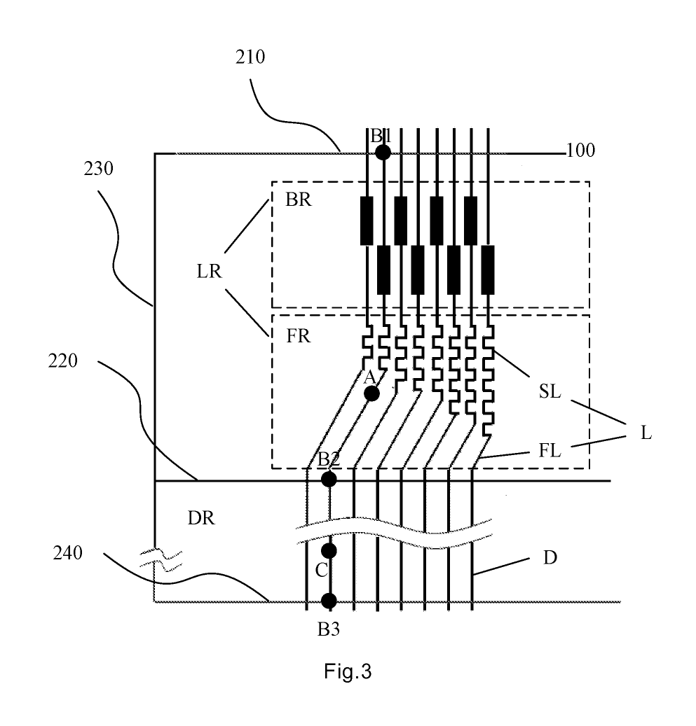

Next, how a display substrate can be repaired using the repair circuit according to an embodiment of the present application will be explained with reference to FIG. 3.

FIG. 3 is a schematic view for explaining how a display substrate can be repaired using the repair circuit according to an embodiment of the present application.

Referring to FIG. 3, it shows the repair circuit 200′ for the display substrate 100 as shown in FIG. 2. However, the present application is not limited to this. The display substrate can also be repaired using the repair circuit 200 as shown in FIG. 1. In addition, for the purpose of clarity, the lead region LR of the display substrate 100 is amplified in FIG. 3. It should be recognized that regions shown in FIG. 3 are not drawn to scale.

As shown in FIG. 3, the lead wire L arranged in the lead region LR provides a data signal to a data line D arranged in the display region DR. According to an embodiment of the present application, the lead region LR can comprise an integrated circuit bonding region BR and a fan-out region FR adjacent to the integrated circuit bonding region BR. The fan-out region FR can be arranged between the integrated circuit bonding region BR and the display region DR. The first repair line 210 can be arranged at a side of the integrated circuit bonding region BR away from the display region DR, and the second repair line 220 can be arranged between the fan-out region FR and the display region DR.

According to an embodiment of the present application, a lead wire L arranged in the fan-out region FR can comprise a snakelike lead wire SL and a fan-out line FL that connects the snakelike lead line SL to the data line D arranged in the display region DR.

When the lead wire L arranged in the lead region LR is disconnected, for example, when the lead wire L is disconnected at point A as shown in FIG. 3, the first repair line 210 and the second repair line 220 can be electrically connected with the disconnected lead wire L respectively, so as to repair the disconnected lead wire L through a conductive path formed by the first repair line 210, the second repair line 220 as well as the third repair line 230 connected to the first repair line 210 and the second repair line 220.

Although in FIG. 3 a disconnection occurs on the fan-out line FL, the present application is not limited to this, and the disconnection can also occur on the snakelike lead wire SL. When the snakelike lead wire SL of the lead wire L is disconnected, the repairing process as described above can also be applied to repair the disconnected lead wire L.

According to an embodiment of the present application, the first repair line 210 and the second repair line 220 can be electrically connected with the disconnected lead wire L respectively through a laser welding method. Insulating layers arranged between the first repair line 210/the second repair line 220 and the disconnected lead wire L are melted by laser. I.e., laser welding positions are formed at intersection points B1 and B2 between the first repair line 210/the second repair line 220 and the disconnected lead wire L respectively. At the laser welding positions, the first repair line 210 and the second repair line 220 are electrically connected with the disconnected lead wire L respectively.

According to an embodiment of the present application, when the data line D arranged in the display region DR is disconnected, for example, when the data line D is disconnected at point C as shown in FIG. 3, the fourth repair line 240 can be electrically connected with the disconnected data line D, and the second repair line 220 can be electrically connected with a lead wire L that is connected to the disconnected data line D. In this way, the disconnected data line D can be repaired through a conductive path formed by the second repair line 220, the fourth repair line 240 as well as the third repair line 230 connected to the second repair line 220 and the fourth repair line 240.

According to an embodiment of the present application, the fourth repair line 240 can be electrically connected with the disconnected data line D and the second repair line 220 can be electrically connected with a lead wire L that is connected to the disconnected data line D through a laser welding method. The insulating layer arranged between the fourth repair line 240 and the disconnected data line D is melted by laser, and the insulating layer arranged between the second repair line 220 and a lead wire L that is connected to the disconnected data line D is melted. I.e., laser welding positions are formed at the intersection point B2 between the second repair line 220 and the lead wire L as well as the intersection point B3 between the fourth repair line 240 and the data line D respectively. At the laser welding positions, the second repair line 220 is electrically connected with the lead wire L, and the fourth repair line 240 is electrically connected with the data line D.

Although not shown in the drawings, the repair circuit arranged on the display substrate can further comprise an amplifying circuit. For example, when the resistivity of the metal material used within the display substrate is relatively high or the size of the display substrate is relatively large, the resistance of the repair circuit formed by said metal material will be relatively high. Hence, signals applied to the pixel of the display substrate may be affected. Influences caused by high resistance of the repair circuit can be overcome by arranging the amplifying circuit.

Although it is shown in the drawings that one repair circuit is arranged on the display substrate, the present application is not limited to it. Two or more repair circuits can also be arranged based on specific application conditions (e.g., line number that can be provided by the amplifying circuit arranged inside and/or the density of wirings arranged at the peripheral of the display substrate).

The repair circuit according to the present application can be applied on a display substrate comprising a display region and a lead region arranged outside the display region, so as to repair disconnections that occur on lead wires of the lead region and/or data lines of the display region.

The display substrate comprising the repair circuit according to the present application can be applied in various display devices, including (but not limited to) any display device comprising a display, such as a computer, a Ultra Mobile Personal Computer (UMPC), a work station, a netbook, a PDA, a portable computer, a wireless phone, a mobile phone, an electronic book, a portable multimedia player (PMP), a portable game machine, a navigation device, a black box, a digital camera, a three-dimensional television, a digital audio recorder, a digital audio player, a digital picture recorder, a digital picture player, a digital video recorder, a digital video player etc.

According to another aspect of the present application, a method for repairing the display substrate using the repair circuit according to the present application is provided. Referring to FIG. 3, the repair method comprises: when the lead wire L arranged in the lead region LR is disconnected, for example, when the lead wire L is disconnected at point A as shown in FIG. 3, enabling the first repair line 210 and the second repair line 220 to be electrically connected with the disconnected lead wire L respectively, so as to repair the disconnected lead wire L through a conductive path formed by the first repair line 210, the second repair line 220 as well as the third repair line 230 connected to the first repair line 210 and the second repair line 220.

According to an embodiment of the present application, the first repair line 210 and the second repair line 220 can be electrically connected with the disconnected lead wire L respectively through a laser welding method.

Referring to FIG. 3, according to an embodiment of the present application, the repair method can further comprise: when a data line D arranged in the display region DR is disconnected, for example, when the data line D is disconnected at point C as shown in FIG. 3, enabling the fourth repair line 240 to be electrically connected with the disconnected data line D, and enabling the second repair line 220 to be electrically connected with a lead wire L that is connected to the disconnected data line D, so as to repair the disconnected data line D through a conductive path formed by the second repair line 220, the fourth repair line 240 as well as the third repair line 230 connected to the second repair line 220 and the fourth repair line 240.

According to an embodiment of the present application, the fourth repair line 240 can be electrically connected with the disconnected data line D, and the second repair line 220 can be electrically connected with the lead wire L that is connected to the disconnected data line D through a laser welding method.

In the repair circuit and repair method for a display substrate according to the present application, when the lead wire arranged in the lead region of the display substrate is disconnected, the disconnected lead wire can be repaired through a lead open (LO) repair circuit (which comprises the first repair line to the third repair line) reserved in the display substrate, without having to consider whether the lead open occurs inside or outside the liquid crystal cell. Hence, the repair circuit and repair method for a display substrate according to the present application can repair lead opens that occur both inside and outside the liquid crystal cell.

Although exemplary embodiments have been shown and described above, a skilled person in the art should be clear that various modifications and variations can be made without departing from the scope of the concept of the present application defined by the claims as attached.

1. A repair circuit for a display substrate, the display substrate comprising a display region and a lead region arranged outside the display region, the repair circuit comprising:
a first repair line, arranged at a side of the lead region away from the display region and intersecting with a lead wire in the lead region;
a second repair line, arranged at a side of the lead region close to the display region and intersecting with a lead wire in the lead region; and
a third repair line that connects the first repair line to the second repair line,
wherein the lead wire in the lead region is electrically insulated from the first repair line and the second repair line.

2. The repair circuit according to claim 1, wherein a data signal is provided to a data line arranged in the display region through the lead wire arranged in the lead region.

3. The repair circuit according to claim 1, wherein the lead region comprises an integrated circuit bonding region and a fan-out region adjacent to the integrated circuit bonding region, and the fan-out region is arranged between the integrated circuit bonding region and the display region,
wherein the first repair line is arranged at a side of the integrated circuit bonding region away from the display region, and the second repair line is arranged between the fan-out region and the display region.

4. The repair circuit according to claim 3, wherein a lead wire arranged in the fan-out region comprises a snakelike lead wire and a fan-out line that connects the snakelike lead wire to the data line arranged in the display region.

5. The repair circuit according to claim 1, wherein the first repair line and the second repair line are configured, when the lead wire arranged in the lead area is disconnected, to be electrically connected with the disconnected lead wire respectively, so as to repair the disconnected lead wire through a conductive path formed by the first repair line, the second repair line as well as the third repair line connected to the first repair line and the second repair line.

6. The repair circuit according to claim 5, wherein the first repair line and the second repair line are electrically connected with the disconnected lead wire respectively through a laser welding method.

7. The repair circuit according to claim 1, further comprising:
a fourth repair line, arranged at a side of the display region away from the lead region and intersecting with but insulated from a data line arranged in the display region,
wherein the third repair line connects the first repair line and the second repair line to the fourth repair line.

8. The repair circuit according to claim 7, wherein the fourth repair line and the second repair line are configured, when the data line arranged in the display region is disconnected, to enable the fourth repair line to be electrically connected with the disconnected data line, and enable the second repair line to be electrically connected with a lead wire that is connected to the disconnected data line, so as to repair the disconnected data line through a conductive path formed by the second repair line, the fourth repair line as well as the third repair line connected to the second repair line and the fourth repair line.

9. The repair circuit according to claim 8, wherein the fourth repair line is electrically connected with the disconnected data line and the second repair line is electrically connected with a lead wire connected to the disconnected data line through a laser welding method.

10. A display substrate, comprising:
a display region;
a lead region arranged outside the display region; and
the repair circuit according to claim 1.

11. A display device, comprising the display substrate according to claim 10.

12. A repair method for a display substrate, wherein the display substrate comprises a display region and a lead region arranged outside the display region, and a repair circuit comprises: a first repair line, arranged at a side of the lead region away from the display region and intersecting with a lead wire in the lead region; a second repair line, arranged at a side of the lead region close to the display region and intersecting with a lead wire in the lead region; and a third repair line that connects the first repair line to the second repair line, wherein the lead wire in the lead region is electrically insulated from the first repair line and the second repair line, the repair method comprising:
when the lead wire arranged in the lead region is disconnected, enabling the first repair line and the second repair line to be electrically connected with the disconnected lead wire respectively, so as to repair the disconnected lead wire through a conductive path formed by the first repair line, the second repair line as well as the third repair line connected to the first repair line and the second repair line.

13. The repair method according to claim 12, wherein the first repair line and the second repair line are electrically connected with the disconnected lead wire respectively through a laser welding method.

14. The repair method according to claim 12, wherein the repair circuit further comprises: a fourth repair line, arranged at a side of the display region away from the lead region and intersecting with but insulated from a data line arranged in the display region, and wherein the third repair line connects the first repair line and the second repair line to the fourth repair line, the repair method further comprises:
when the data line arranged in the display region is disconnected, enabling the fourth repair line to be electrically connected with the disconnected data line, and enabling the second repair line to be electrically connected with a lead wire that is connected to the disconnected data line, so as to repair the disconnected data line through a conductive path formed by the second repair line, the fourth repair line as well as the third repair line connected to the second repair line and the fourth repair line.

15. The repair method according to claim 14, wherein the fourth repair line is electrically connected with the disconnected data line and the second repair line is electrically connected with a lead wire connected to the disconnected data line through a laser welding method.

16. The display substrate according to claim 10, wherein a data signal is provided to a data line arranged in the display region through the lead wire arranged in the lead region.

17. The display substrate according to claim 10, wherein the lead region comprises an integrated circuit bonding region and a fan-out region adjacent to the integrated circuit bonding region, and the fan-out region is arranged between the integrated circuit bonding region and the display region,
wherein the first repair line is arranged at a side of the integrated circuit bonding region away from the display region, and the second repair line is arranged between the fan-out region and the display region.

18. The display substrate according to claim 17, wherein a lead wire arranged in the fan-out region comprises a snakelike lead wire and a fan-out line that connects the snakelike lead wire to the data line arranged in the display region.

19. The display substrate according to claim 10, wherein the first repair line and the second repair line are configured, when the lead wire arranged in the lead area is disconnected, to be electrically connected with the disconnected lead wire respectively, so as to repair the disconnected lead wire through a conductive path formed by the first repair line, the second repair line as well as the third repair line connected to the first repair line and the second repair line.

20. The display substrate according to claim 10, further comprising:
a fourth repair line, arranged at a side of the display region away from the lead region and intersecting with but insulated from a data line arranged in the display region,
wherein the third repair line connects the first repair line and the second repair line to the fourth repair line.
